(19) United States
(12) Patent Application Publication
(10) Pub. No.: US 2012/0044215 A1
(43) Pub. Date: Feb. 23, 2012

(54) Memory Circuit, Pixel Circuit, and Data Accessing Method Thereof

(76) Inventors: Szu-Han Chen, Hsin-Chu (TW); Ming-Dou Ker, Hsin-Chu (TW); Yu-Hsuan Li, Hsin-Chu (TW)

(21) Appl. No.: 13/104,989

(22) Filed: May 11, 2011

(30) Foreign Application Priority Data
Aug. 19, 2010 (TW) 099127709

(51) Int. Cl. G06F 3/038

(52) U.S. Cl. 345/204

(57) ABSTRACT

A pixel circuit includes a pixel unit and a memory circuit. The memory circuit includes a first switch, a switch unit, a second switch, and a plurality of memory units. Each of the memory units includes a third switch and a capacitor, where the capacitors of the memory units have a same capacitance. A data accessing method applied on the pixel circuit includes determining an order of writing a plurality of first voltages, which are loaded from a data line, according to weights of bits within a first bit string, where the bits are respectively corresponding to the first voltages, and includes determining an order and loading durations of loading a plurality of second voltages, which are previously stored in the memory units, according to weights of bits within a second bit string, where the bits are respectively corresponding to the second voltages.

### BACKGROUND

1. Technical Field

The present invention is related to memory circuits, pixel circuits, and related data access methods, and more particularly to a memory circuit and pixel circuit that comprise memory units having a plurality of capacitors of essentially equal capacitance, and a data access method that utilizes different time intervals to read a plurality of voltages.

2. Related Art

Please refer to FIG. 1, which is a simplified diagram of a liquid crystal panel 100. As shown in FIG. 1, the liquid crystal panel 100 comprises a display control integrated circuit 130, a data driving module 140, and a pixel array module 150. The liquid crystal panel 100 utilizes the display control integrated circuit 130 to receive power from a power supply integrated circuit 110, and signals transmitted by a local computer 120. The data driving module 140 displays images corresponding to the signals, and determines driving of a plurality of pixel units ordered in an array comprised by the pixel array module 150 according to the signals for displaying an image corresponding to the signals. When the liquid crystal panel 100 enters a standby mode, the local computer 120 transmits a signal having only fixed static frames to the display control integrated circuit 130. Thus, the data driving module 140 only needs to generate a corresponding monotone driving signal continuously to drive the pixel array module 150. However, such meaningless, continuous generation of the driving signal incurs a noticeable drain of power in the data driving module 140 even in standby mode, causing the liquid crystal panel 100 itself to experience an unnecessarily large waste of power as well.

### SUMMARY

According to an embodiment, a memory circuit comprises a first switch, a switch unit, a second switch, and a plurality of memory units. The first switch is coupled to a pixel unit, and is turned on when reading data from the pixel unit for receiving a plurality of first voltages from the pixel unit. The first voltages individually correspond to a plurality of bits comprised by a first bit string. The switch unit is coupled to the first switch for controlling switching of a data read mode or a data write mode of the pixel unit. The second switch is coupled to the pixel unit, and is turned on when writing data to the pixel unit for receiving a plurality of second voltages from the switch unit. The second voltages individually correspond to a plurality of bits comprised by a second bit string. The plurality of memory units are coupled to the switch unit. Each memory unit comprises a third switch turned on when the memory unit is utilized for storing the first voltage or reading the second voltage, and a capacitor comprising a first terminal coupled to a first terminal of the third switch, and a second terminal coupled to ground. Capacitances of the capacitors comprised by the plurality of memory units are essentially equal.

According to an embodiment, a pixel circuit comprises a pixel unit, and a memory circuit. The memory circuit comprises a first switch, a switch unit, a second switch, and a plurality of memory units. The first switch is coupled to the pixel unit, and is turned on when reading data from the pixel unit for receiving a plurality of first voltages from the pixel unit. The first voltages individually correspond to a plurality of bits comprised by a first bit string. The switch unit is coupled to the first switch for controlling switching of a data read mode or a data write mode of the pixel unit. The second switch is coupled to the pixel unit, and is turned on when writing data to the pixel unit for receiving a plurality of second voltages from the switch unit. The second voltages individually correspond to a plurality of bits comprised by a second bit string. The plurality of memory units are coupled to the switch unit. Each memory unit comprises a third switch turned on when the memory unit is utilized for storing the first voltage or reading the second voltage, and a capacitor comprising a first terminal coupled to a first terminal of the third switch, and a second terminal coupled to ground. Capacitances of the capacitors comprised by the plurality of memory units are essentially equal.

According to an embodiment, a data access method utilized in a pixel circuit for enabling the pixel circuit comprises, determining individual read interval lengths for reading a plurality of second voltages from the memory units according to individual corresponding positions in a second bit string of the second voltages originally stored in the memory units, and reading the second voltages from the memory units. The data access method further comprises transmitting the read second voltages to the pixel unit. The read interval lengths individually corresponding to the second voltages are different.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified diagram of a liquid crystal panel.

FIG. 2 is a diagram of a pixel circuit according to an embodiment.

FIG. 3 is a timing diagram of the pixel circuit of FIG. 2 when the pixel unit enters the data read mode or the data write mode.

FIG. 4 is a flow chart of a data access method based on the voltage writing/reading method disclosed in FIG. 2 and FIG. 3.

### DETAILED DESCRIPTION

In order to solve the problem of noticeable, unnecessary power consumption caused by the data driving module of the general liquid crystal panel continuously generating the driving signals corresponding to static frames to drive the pixel array module in standby mode, a memory circuit, a pixel circuit comprising the memory circuit, and a data access method utilized for enabling the pixel circuit are disclosed. In this way, even if the liquid crystal panel is in standby mode, the data driving module need not generate driving signals corresponding to static frames for driving the pixel array module, which avoids unnecessary power waste.

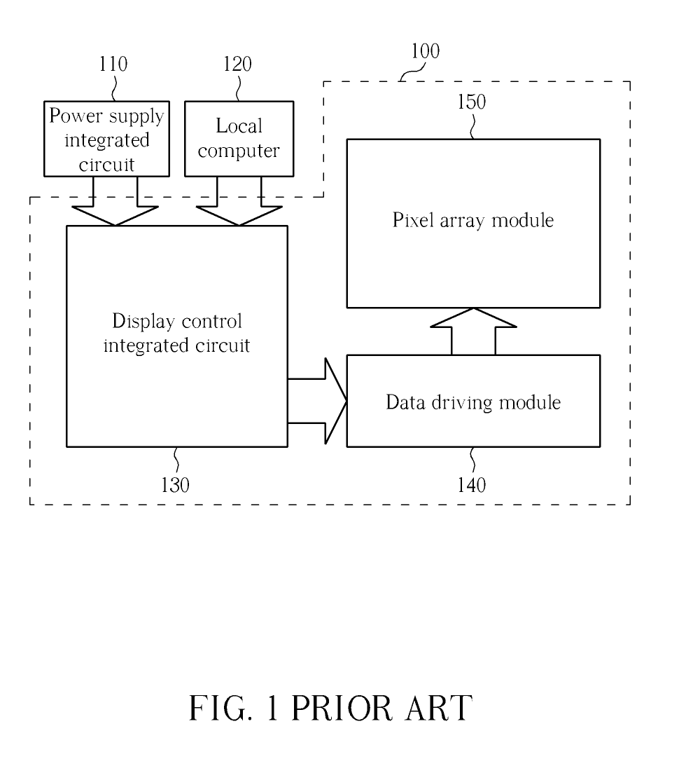

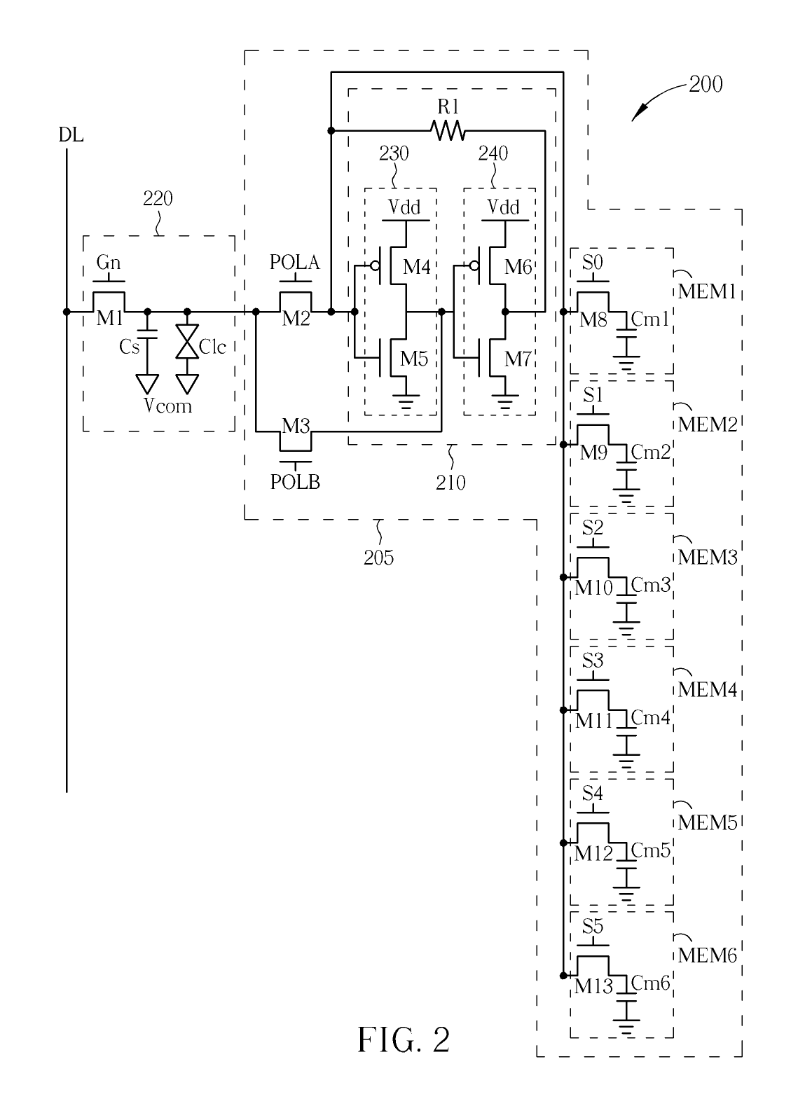

Please refer to FIG. 2, which is a diagram of a pixel circuit 200 according to an embodiment. The pixel circuit 200 is utilized for replacing the plurality of pixel units ordered in an array comprised by the pixel array module 150 shown in FIG. 1. As shown in FIG. 2, the pixel circuit 200 comprises a pixel unit 220, and a memory circuit 205. The pixel unit 220 comprises a switch M1, a storage capacitor Cs, and a parallel plate capacitor Clc, and is utilized for reading a data signal from a data line DL (not shown in FIG. 1) arranged on the pixel array module 150 shown in FIG. 1, then storing the data signal on the storage capacitor Cs. When the data signal represents a first bit string, the data signal may be stored on the storage capacitor Cs at different times in the form of a plurality of first voltages representing high voltage or low voltage. These first voltages each correspond to the plurality of bits comprised by the first bit string. The storage capacitor Cs and the parallel plate capacitor Clc are both coupled to a common voltage node Vcom as shown in FIG. 2.

The memory circuit 205 comprises switches M2, M3, a switch unit 210, and a plurality of memory units MEM1, MEM2, MEM3, MEM4, MEM5, MEM6. The switch M2 is turned on when the pixel unit 220 reads the data signal from the data line DL for receiving the plurality of first voltages. The switch unit 210 is coupled to the switches M2, M3. When the switch M2 is turned on, the pixel unit 220 enters a data read mode, and when the switch M3 is turned on, the pixel unit 220 enters a data write mode. The data read mode represents a process of the plurality of first voltages being read into the plurality of memory units MEM1-MEM6 from the data line DL, and the data write mode represents a process of a plurality of second voltages being read out from the memory units MEM1-MEM6, and written into the pixel unit 220. Each second voltage of the plurality of second voltages corresponds to one bit comprised by a second bit string. Please note that, for the sake of simple illustration, FIG. 2 only shows six memory units MEM1-MEM6, each utilized for storing one of the first voltages in the data read mode, or having one of the second voltage read from it in the data write mode, but the number of memory units comprised by the memory circuit 205 is not limited to the six shown in FIG. 2 in the present embodiment.

The switch unit 210 comprises a first inverting module 230, a second inverting module 240, and a resistor R1. A first input terminal of the first inverting module 230 is coupled to the memory units MEM1-MEM6, and an output terminal of the first inverting module 230 is coupled to the switch M3. An input terminal of the second inverting module 240 is coupled to the output of the first inverting module 230, and an output of the second inverting module 240 is coupled to the memory units MEM1-MEM6.

The first inverting module 230 comprises an N-type MOS transistor M5 and a P-type MOS transistor M4. A gate of the N-type MOS transistor M5 is coupled to the memory units MEM1-MEM6, and a drain of the N-type MOS transistor M5 is coupled to ground. A gate of the P-type MOS transistor M4 is coupled to the gate of the N-type MOS transistor M5, a source of the P-type MOS transistor M4 is coupled to a voltage source Vdd, and a drain of the P-type MOS transistor M4 is coupled to the drain of the N-type MOS transistor M5. The second inverting module 240 comprises an N-type MOS transistor M7, and a P-type MOS transistor M6. A gate of the N-type MOS transistor M7 is coupled to the drain of the N-type MOS transistor M5, and a drain of the N-type MOS transistor M7 is coupled to ground. A gate of the P-type MOS transistor M6 is coupled to the gate of the N-type MOS transistor M7. A source of the P-type MOS transistor M6 is coupled to the voltage source Vdd, and a drain of the P-type MOS transistor M6 is coupled to the drain of the N-type MOS transistor M7. A first terminal of the resistor R1 is coupled to the drain of the N-type MOS transistor M7, and a second terminal of the resistor R1 is coupled to the memory units MEM1-MEM6.

The memory units MEM1-MEM6 are all coupled to the switch unit 210. The memory units MEM1-MEM6 each comprise a switch and a capacitor. For example, the memory unit MEM1 comprises switch M8 and capacitor Cm1, the memory unit MEM2 comprises switch M9 and capacitor Cm2, the memory unit MEM3 comprises switch M10 and capacitor Cm3, the memory unit MEM4 comprises switch M11 and capacitor Cm4, memory unit MEM5 comprises switch M12 and capacitor Cm5, memory unit MEM13 comprises switch M13 and capacitor Cm6. Capacitances of the capacitors Cm1-Cm6 are essentially equal. When the pixel unit 220 enters the data read mode, the switches M8-M13 are turned on in turn according to a data read sequence, such that when the pixel unit 220 enters the data read mode, the memory units MEM1-MEM6 may be utilized individually for reading the first voltages through the switch unit 210, and storing the first voltages onto the capacitors Cm1-Cm6. When the pixel unit 220 enters the data write mode, the switches are turned on, such that the second voltage stored on each memory unit is read, and written to the pixel unit 220 through the switch unit 210.

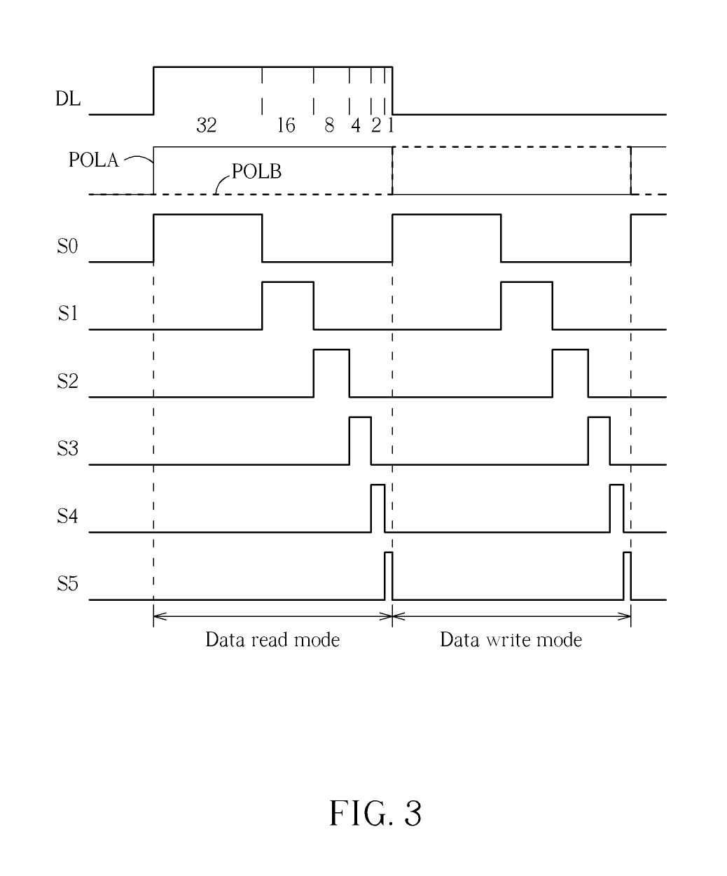

Please refer to FIG. 3, which is a timing diagram of the pixel circuit 200 of FIG. 2 when the pixel unit 220 enters the data read mode or the data write mode. FIG. 3 shows levels of the data line DL, control terminals POLA, POLB of the switches M2, M3, and control terminals S0, S1, S2, S3, S4, S5 of the memory units MEM1-MEM6 shown in FIG. 2. For the sake of simple illustration of the data read mode with respect to FIG. 2, it is assumed that the first bit string during the data read mode is “111111”. From left to right, these bits individually represent decimal values of 32, 16, 8, 4, 2, 1 in the bit string (as marked in FIG. 3 in the waveform region corresponding to the data line DL), namely the plurality of first voltages individually represent a high voltage level. When the pixel unit 220 shown in FIG. 2 enters the data read mode, the control terminal Gn of the switch M1 is enabled, such that the plurality of first voltages read from the data line DL are stored by the storage capacitor Cs in order according to the positions of the plurality of first bits in the first bit string. As shown in FIG. 2 and FIG. 3, in the data read mode, the control terminal POLA of the switch M2 is enabled to turn on the switch M2, such that the gates of the P-type MOS transistor M4 and the N-type MOS transistor M5 are at the high voltage level, the P-type MOS transistor M4 is turned off and the N-type MOS transistor M5 is turned on, and the gates of the P-type MOS transistor M6 and the N-type MOS transistor M7 are pulled down to a low voltage level. In this way, the P-type MOS transistor M6 is turned on, and the N-type MOS transistor M7 is turned off, such that the plurality of first voltages sent to the gate of the P-type MOS transistor M4 obtain a voltage increase from the voltage source Vdd through the switch M6 and the resistor R1. The control terminals S0-S5 of the switches M8-M13 are enabled in order according to the positions of the first bits in the first bit string to write and store the first bits onto the capacitors Cm1-Cm6 comprised by the memory units MEM1-MEM6, respectively. Taking FIG. 3 as an example, the control terminals S0-S5 are enabled in the order S0, S1, S2, S3, S4, S5. Namely, the order in which the memory units MEM1-MEM6 store the six first voltages is MEM1, MEM2, MEM3, MEM4, MEM5, MEM6. The memory unit MEM1 stores the bit corresponding to the highest position of the first bit string, and the memory unit MEM6 stores the bit corresponding to the lowest position of the first bit string.

Please refer again to FIG. 2 and FIG. 3. In the data write mode, assuming the memory units MEM1-MEM6 individually store six second voltages, and the control terminals S0-S5 are enabled in the order shown in FIG. 3, the six second voltages are read out from the memory units MEM1-MEM6 in order according to positions of the corresponding second bits in the second bit string. The memory unit MEM1 stores the bit corresponding to the highest position in the second bit string, and the memory unit MEM6 stores the bit corresponding to the lowest position in the second bit string. It is assumed here that all of the second voltages are at the high voltage level, i.e. the second bit string is “111111”. It can be understood from the description of the inverting modules 230, 240 in the data read mode that the gates of the P-type MOS transistor M6 and the N-type MOS transistor M7 are at the low voltage level. In the data read mode, the switch M1 is turned off for stopping reading of signals transmitted over the data line DL, and the switch M3 is turned on for sending the low voltage level at the gates of the P-type MOS transistor M6 and the N-type MOS transistor M7 to the parallel plate capacitor Clc. Thus, voltage levels of the plurality of second voltages may be read simply by performing detection on a node located at one terminal of the parallel plate capacitor Clc. For example, when the sent low voltage described above is read on the node Lc, it can be determined directly that the corresponding second bit is “1”, representing the high voltage level. This is due to the single second voltage undergoing one voltage inversion by the inverting module 230 during the process of reading the single second voltage out from the memory units MEM1-MEM6.

Through observation of FIG. 3, it can be understood that when the method of the present embodiment operates in the data read mode, different bits/voltages read from the second bit string are read at different times corresponding to position of each bit. For example, if capacitances of the capacitors Cm1-Cm6 are essentially equal, the corresponding read time intervals of bits at higher positions are longer, showing that the corresponding voltages of the higher position bits are higher. However, in other embodiments, the read time intervals of lower position bits may be longer than the read time intervals of higher position bits, as long as different bits/voltages have different read time interval lengths, such that positions represented by read bits/voltages can be distinguished clearly. Different read time interval lengths of different bits/voltages of the second bit string are one characterizing feature of the method of the present embodiment.

In the data write mode shown in FIG. 3, data write interval lengths for writing different bits/voltages of the first bit string are also different. However, in other embodiments, the data write interval lengths for writing the different bits/voltages may be the same. It is also not necessary for higher position bits/voltages to correspond to longer data write intervals. Please note that, in the embodiments, the abovementioned setting of the read interval lengths for reading the different bits/voltages of the second bit string and the setting of the write interval lengths for writing the different bits/voltages of the first bit string are mutually independent, and not limited to those shown in FIG. 3.

In a preferred embodiment, data read interval lengths and data write interval lengths are the same for reading and writing of the same bits/voltages of a bit string. For example, if higher position of different bits/voltages in a bit string corresponds to longer data read interval length, in the preferred embodiment, higher position of different bits/voltage in the bit string corresponds to longer data write interval length, such that timing settings for reading and writing of the bit string are identical. By using capacitors having essentially the same capacitance in the memory units, circuit design complexity of the memory units is dramatically reduced.

FIG. 3 shows total length of time for executing the data read mode or the data write mode. Total data read time for reading a single second bit string, or total data write time for writing a single first bit string, may be equal to turn on time of a single scan line, turn on time of a plurality of scan lines, access time of a single frame, or access time of a plurality of frames.

Although order of writing or reading voltages shown in FIG. 3 is performed according to order of the memory units MEM1-MEM6 (i.e. according to enabling order of the control terminals S0-S5), in other embodiments, order of writing or reading voltages in the memory units MEM1-MEM6 (or a different number of memory units) and corresponding writing/reading voltage intervals only need be performed according to different corresponding bit positions of the bit string, and are not limited to being performed according to order of bits from high to low position or relative interval lengths.

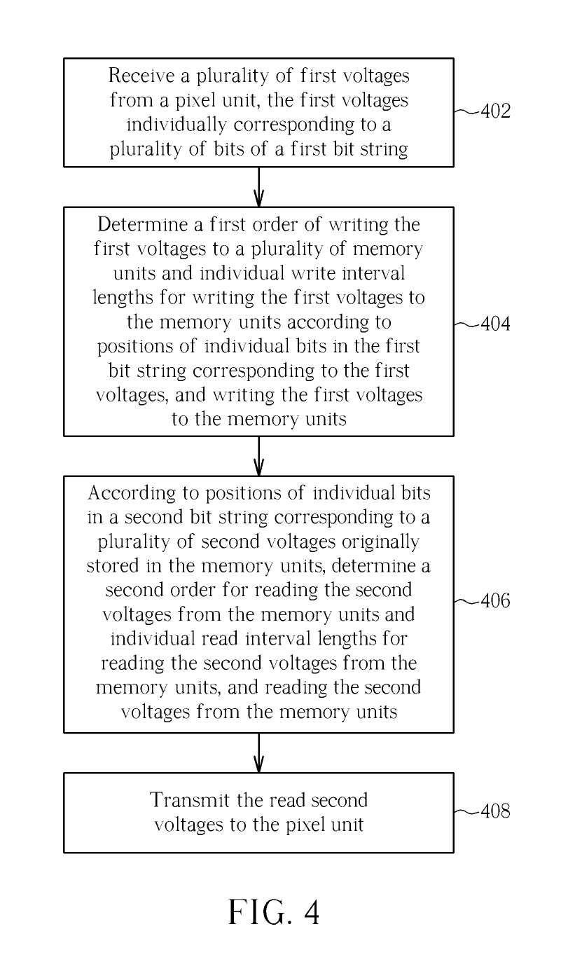

Please refer to FIG. 4, which is a flow chart of a data access method based on the voltage writing/reading method disclosed in FIG. 2 and FIG. 3. As shown in FIG. 4, the data access method comprises the following steps:

Step 402: Receive a plurality of first voltages from a pixel unit, the first voltages individually corresponding to a plurality of bits of a first bit string;

Step 404: Determine a first order of writing the first voltages to a plurality of memory units and individual write interval lengths for writing the first voltages to the memory units according to positions of individual bits in the first bit string corresponding to the first voltages, and writing the first voltages to the memory units, wherein the write interval lengths individually corresponding to the first voltages are different;

Step 406: According to positions of individual bits in a second bit string corresponding to a plurality of second voltages originally stored in the memory units, determine a second order for reading the second voltages from the memory units and individual read interval lengths for reading the second voltages from the memory units, and reading the second voltages from the memory units; and

Step 408: Transmit the read second voltages to the pixel unit.

Steps 402 and 404 describe reading the plurality of first voltages from the data line DL in the data read mode, and the process of writing the first voltages to the memory units MEM1-MEM6 according to the corresponding bit positions. The first sequence described in step 404 corresponds to the sequence shown in FIG. 3 for writing the first voltages to the memory units MEM1-MEM6. Steps 406 and 408 describe the reading process whereby the memory units MEM1-MEM6 write the second voltages to the pixel unit 220 according to the corresponding bit positions thereof. The second sequence described in step 406 corresponds to the sequence shown in FIG. 3 for reading the second voltages from the memory units MEM1-MEM6. Embodiments derived from the disclosure of FIG. 4 by adding other conditions described above or changing order of the steps should be considered embodiments of the invention.

The embodiments describe a memory circuit, a pixel circuit comprising the memory circuit, and a data access method utilized in the pixel circuit. By determining sequence and/or interval length for reading or writing a plurality of voltages according to corresponding bit positions of the voltages in a bit string, the embodiments make it possible to save power in the standby mode. When the touch panel needs to enter the standby mode, the second voltages at the high voltage level or the low voltage level (namely the second bit string having bits “111111” or “000000”) previously stored in the memory units are read continually. Thus, the data driving module 140 shown in FIG. 1 may drive the pixel array module without need for further generation of bit strings, which saves power. Also, as the capacitances of the capacitors comprised by the memory units are all the same for generating the different read/write intervals, area of the pixel circuit 200 is reduced in fabrication, which decreases overall area needed to manufacture the liquid crystal panel 100.

Those skilled in the art will readily observe that numerous modifications and alterations of the device and method may be made while retaining the teachings of the invention.

What is claimed is:

1. A memory circuit comprising:
a first switch coupled to a pixel unit, the first switch turned on when reading data from the pixel unit for receiving a plurality of first voltages from the pixel unit, wherein the first voltages individually correspond to a plurality of bits comprised by a first bit string;
a switch unit coupled to the first switch for controlling switching of a data read mode or a data write mode of the pixel unit;
a second switch coupled to the pixel unit, the second switch turned on when writing data to the pixel unit for receiving a plurality of second voltages from the switch unit, wherein the second voltages individually correspond to a plurality of bits comprised by a second bit string; and
a plurality of memory units coupled to the switch unit, each memory unit comprising:
a third switch turned on when the memory unit is utilized for storing the first voltage or reading the second voltage; and
a capacitor comprising a first terminal coupled to a first terminal of the third switch, and a second terminal coupled to ground, wherein capacitances of the capacitors comprised by the plurality of memory units are essentially equal.

2. The memory circuit of claim 1, wherein the switch unit comprises:
a first inverting module comprising an input terminal coupled to the memory units, and an output terminal coupled to the second switch; and
a second inverting module comprising a first terminal coupled to the output terminal of the first inverting module, and an output terminal coupled to the memory units.

3. The memory circuit of claim 2,
wherein the first inverting module comprises:
a first N-type metal-oxide-semiconductor (MOS) transistor comprising a gate coupled to the memory units, and a drain coupled to ground; and
a first P-type MOS transistor comprising a gate coupled to the gate of the first N-type MOS transistor, a source coupled to a voltage source, and a drain coupled to a drain of the first N-type MOS transistor;
wherein the second inverting module comprises:
a second N-type MOS transistor comprising a gate coupled to the drain of the first N-type MOS transistor, and a drain coupled to ground; and
a second P-type MOS transistor comprising a gate coupled to the gate of the second N-type MOS transistor, a source coupled to the voltage source, and a drain coupled to the drain of the second N-type MOS transistor.

4. The memory circuit of claim 3, wherein the switch unit further comprises:
a resistor comprising a first terminal coupled to the drain of the second N-type MOS transistor, and a second terminal coupled to the memory units.

5. A pixel circuit comprising:
a pixel unit; and
a memory circuit comprising:
a first switch coupled to the pixel unit, the first switch turned on when reading data from the pixel unit for receiving a plurality of first voltages from the pixel unit, wherein the first voltages individually correspond to a plurality of bits comprised by a first bit string;
a switch unit coupled to the first switch for controlling switching of a data read mode or a data write mode of the pixel unit;
a second switch coupled to the pixel unit, the second switch turned on when writing data to the pixel unit for receiving a plurality of second voltages from the switch unit, wherein the second voltages individually correspond to a plurality of bits comprised by a second bit string; and
a plurality of memory units coupled to the switch unit, each memory unit comprising:
a third switch turned on when the memory unit is utilized for storing the first voltage or reading the second voltage; and
a capacitor comprising a first terminal coupled to a first terminal of the third switch, and a second terminal coupled to ground, wherein capacitances of the capacitors comprised by the plurality of memory units are essentially equal.

6. A data access method utilized in a pixel circuit for enabling the pixel circuit of claim 5, the data access method comprising:
according to individual corresponding positions in a second bit string of a plurality of second voltages originally stored in the memory units, determining individual read interval lengths for reading the second voltages from the memory units, and reading the second voltages from the memory units; and
transmitting the read second voltages to the pixel unit;
wherein the read interval lengths individually corresponding to the second voltages are different.

7. The data access method of claim 6, further comprising:
according to individual corresponding positions in a second bit string of a plurality of second voltages originally stored in the memory units, determining a second sequence for reading the second voltages from the memory units.

8. The data access method of claim 6, wherein a total read interval length for reading the second voltages from the memory units is equal to a turned on interval length of a single scan line, a turned on interval length of a plurality of scan lines, an interval length for reading a single image frame, or an interval length for reading a plurality of image frames.

9. The data access method of claim 6, wherein when the second voltages are read from the memory units, enabling of the switch comprised by the memory unit storing a first position bit of the second bit string happens before or after enabling of the switch comprised by the memory unit storing a second position bit of the second bit string, and the first position bit has higher significance than the second position bit in the second bit string.

10. The data access method of claim 6, wherein when the second voltages are read from the memory units, enabling interval of the switch comprised by the memory unit storing a first position bit of the second bit string is longer or shorter than enabling interval of the switch comprised by the memory unit storing a second position bit of the second bit string, and the first position bit has higher significance than the second position bit in the second bit string.

11. The data access method of claim 6, further comprising:
receiving a plurality of first voltages from the pixel unit, the first voltages individually corresponding to a plurality of bits comprised by a first bit string; and
according to individual corresponding bit positions of the first voltages in the first bit string, determining a first sequence for writing the first voltages to the plurality of memory units, and writing the first voltages to the memory units;
wherein individual corresponding write interval lengths of the first voltages are different.

12. The data access method of claim 11, wherein total write interval length for writing the first voltages to the memory units is equal to a turned on interval length of a single scan line, a turned on interval length of a plurality of scan lines, an interval length for writing a single image frame, or an interval length for writing a plurality of image frames.

13. The data access method of claim 11, wherein when the first voltages are written to the memory units, enabling of the switch comprised by the memory unit predetermined for storing a first position bit of the first bit string happens before or after enabling of the switch comprised by the memory unit predetermined for storing a second position bit of the first bit string, and the first position bit has higher significance than the second position bit in the first bit string.

14. The data access method of claim 11, wherein when the first voltages are written to the memory units, enabling interval of the switch comprised by the memory unit predetermined for storing a first position bit of the first bit string is longer or shorter than enabling interval of the switch comprised by the memory unit predetermined for storing a second position bit of the first bit string, and the first position bit has higher significance than the second position bit in the first bit string.

15. The data access method of claim 6, wherein each of the memory units comprises a switch, and when the switch is enabled, the memory unit comprising the switch reads or writes voltage.
